(19) United States
(12) Patent Application Publication
(10) Pub. No.: US 2007/0185635 A1
(43) Pub. Date: Aug. 9, 2007

(54) Occupant-protection system for vehicles and method for activating an occupant-protection system for vehicles

(76) Inventors: Bernhard Mattes, Sachsenheim (DE); Hans-Peter Stumpp, Markgroeningen (DE); Werner Nitschke, Ditzingen (DE); Hartmut Schumacher, Freiberg (DE); Walter Wottreng, Aichtal (DE); Hans Guettler, Untergruppenbach (DE); Rainer Moritz, Filderstadt (DE); Thomas Herrmann, Oehringen (DE); Frank-Juergen Stuetzler, South Lyon, MI (US); Alexander Vogt, Stuttgart (DE); Knut Balzer, Beilstein (DE); Thomas Lich, Schwaikheim (DE); Ulrike Groeger, Howell, MI (US); Alfred Kuttenberger, Nufringen (DE); Lothar Groesgh, Novi, MI (US); Michael Schmid, Kornwestheim (DE); Mario Kroeninger, Buehl (DE)

Correspondence Address: KENYON & KENYON LLP, ONE BROADWAY, NEW YORK, NY, 10004, US

(21) Appl. No.: 10/556,983

(22) PCT Filed: Mar. 16, 2004
(86) PCT No.: PCT/DE04/00524

§ 371 Date: Feb. 16, 2007

(30) Foreign Application Priority Data
May 15, 2003 (DE) 103 21 871.8

(51) Int. Cl. B60R 22/00

(52) U.S. Cl. 701/45

(57) ABSTRACT

An occupant-protection system for vehicles, including: at least one sensor, which detects the surrounding area of the vehicle and generates sensor signals therefrom; an evaluation device, which analyzes the sensor signals, detects an approaching hazardous situation in advance according to an algorithm for the early detection of a hazardous situation and generates a trigger signal in this case; a seat-adjustment device having at least one actuator for adjusting a seat, the seat-adjustment device having a first speed for a comfort adjustment of the seat and a second, higher speed for the seating adjustment of the seat in response to triggering by the trigger signal. Also provided is a method for activating an occupant-protection system for vehicles.

### BACKGROUND INFORMATION

The present invention relates to an occupant-protection system for vehicles as well as a method for activating an occupant-protection for vehicles and, in particular, an occupant-protection system for vehicles that includes sensors for monitoring the surrounding area of a vehicle and an adaptive seating system.

In the area of occupant safety in motor vehicles a system is currently available (PreSafe for the S-class of Mercedes Benz) in which belt tensioners are triggered in the event of emergency braking or skidding of the vehicle to reduce possibly existing belt slack, i.e., a belt that does not fit tightly. In addition, the standard electromotors for the comfort seat adjustment in the longitudinal direction, the seat-cushion tilt and the seat-backrest are activated so as to bring the occupant into a safe position for a possible accident.

Due to the triggering of the standard electromotors used for the comfort adjustment, such activations of the standard seat adjustments require considerable time, which is in the range of seconds. The actions of this known system are therefore merely target-oriented, i.e., they improve occupant protection if sufficient time is available before a potential accident. In emergency braking or skidding, which the known system detects system with the aid of transversal acceleration sensors in conjunction with wheel sensors and steering-angle sensors, sufficient time may possibly remain for a seat-adjustment correction. The sensory system utilized in the PreSafe system is primarily used in vehicle-stability systems such as ESP, ABS and a brake-assistance system. However, this system covers only a few crash types (only following emergency braking or skidding of the vehicle) for triggering the limited protective mechanisms.

### SUMMARY OF THE INVENTION

In contrast to the known design approach (PreSafe), the occupant-protection system for vehicles according to the present invention having the features of Claim 1 and the method for activating an occupant protection system for vehicles having the features of claim 10, have the advantage that a seat is safely activatable by means of a sensor device for detecting the surrounding area of the vehicle in conjunction with faster actuators, even in cases where neither emergency braking nor skidding of the vehicle is present, i.e., only a short time is available for initiating protective measures. This ensures better occupant protection in the event of a possible crash.

The idea on which the present invention is essentially based is the combination of the use of an anticipatory sensory system of a vehicle and a fast actuator system in the vehicle seat, so that an occupant is prepared for a crash even in those cases where no emergency-braking intervention or skidding of the vehicle is detectable.

In other words, an occupant-protection system for vehicles is provided, which includes: at least one sensor, which detects the surrounding area of the vehicle and generates sensor signals therefrom; an evaluation device, which analyzes the sensor signals, detects an approaching hazardous situation in advance according to an algorithm for the advance detection of a hazardous situation and generates a trigger signal in this case; a seat-adjustment device having at least one actuator for the adjustment of a seat, the seat-adjustment device having a first speed for a comfort adjustment of the seat and a second, higher speed for the seating adjustment of the seat in response to triggering by the trigger signal.

Advantageous developments and improvements of the occupant-protection system indicated in Claim 1 are found in the dependent claims.

According to another preferred further development, the at least one actuator deforms the seat surfaces and/or the headrest of the seat as a function of the sensor signals analyzed by an evaluation device at the second adaptation speed in each case and in a reversible manner, and/or it reversibly adjusts the seat position with respect to the steering wheel. Due to the reversibility of the corresponding devices, additional costs after a triggering are avoided.

According to an additional preferred further development, the at least one actuator is made up of a pneumatic system, a high-speed electromotor or an electromotorically tensionable, mechanical spring device, which triggers into its final position in preferably less than one second. This advantageous high-speed actuator system offers improved protection possibilities for occupants while allowing reversibility of the actuators of the seat.

In another preferred further development, a seat wedge, which deforms the seat surface upwardly in response to the trigger signal, is provided at the end of the essentially horizontal seat surface. This has the advantage of actively avoiding the so-called “submarining”, i.e., sliding under the belt, in the event of a potential crash.

According to another preferred further development, in response to the trigger signal the seat is able to be positioned in the direction of a seat-mounting device on the floor of the vehicle and/or away from the steering wheel by means of at least one actuator. This provides greater distance with respect to the vehicle roof and/or the steering wheel in a dangerous situation.

According to a preferred further development, the seat has a device in the rear region of the essentially horizontal seat surface that is able to be moved downward by an actuator and which produces a depression in the rear region of the seat surface in response to a trigger signal. This likewise avoids the so-called “submarining” in an advantageous manner, possibly also in conjunction with a reversible belt tightener.

According to an additional preferred further development, the essentially horizontal seat surface has seat end pieces that are laterally extendable in response to the trigger signal. Activating this side bolster of the seat, i.e., raising the seat end pieces, advantageously reduces lateral sliding of the occupant.

According to another preferred further development, a collar may be moved out of the headrest and/or a head-protection bolster may be slid out of the roof of the vehicle over the seat when the trigger signal occurs. This prevents pivoting motions of the head during a possible crash, or avoids contact with the hard roof in the event of a rollover.

According to another preferred further development, the sensor device has radar sensors and/or video sensors and/or laser-scan-based sensors at the periphery of the vehicle, in particular for monitoring the area in front of the vehicle. This allows an advantageous forward monitoring of the surrounding area of the vehicle with respect to potential dangerous situations.

### BRIEF DESCRIPTION OF THE DRAWINGS

Exemplary embodiments of the present invention are represented in the drawings and more closely explained in the description below.

The figures show:

FIG. 1 A schematic plan view of a motor vehicle having sensory front-region monitoring, to elucidate an aspect of the present invention;

FIG. 2 A schematic side/cross-sectional view of a seat, to elucidate an aspect according to a specific embodiment of the present invention.

### DESCRIPTION OF THE EXEMPLARY EMBODIMENTS

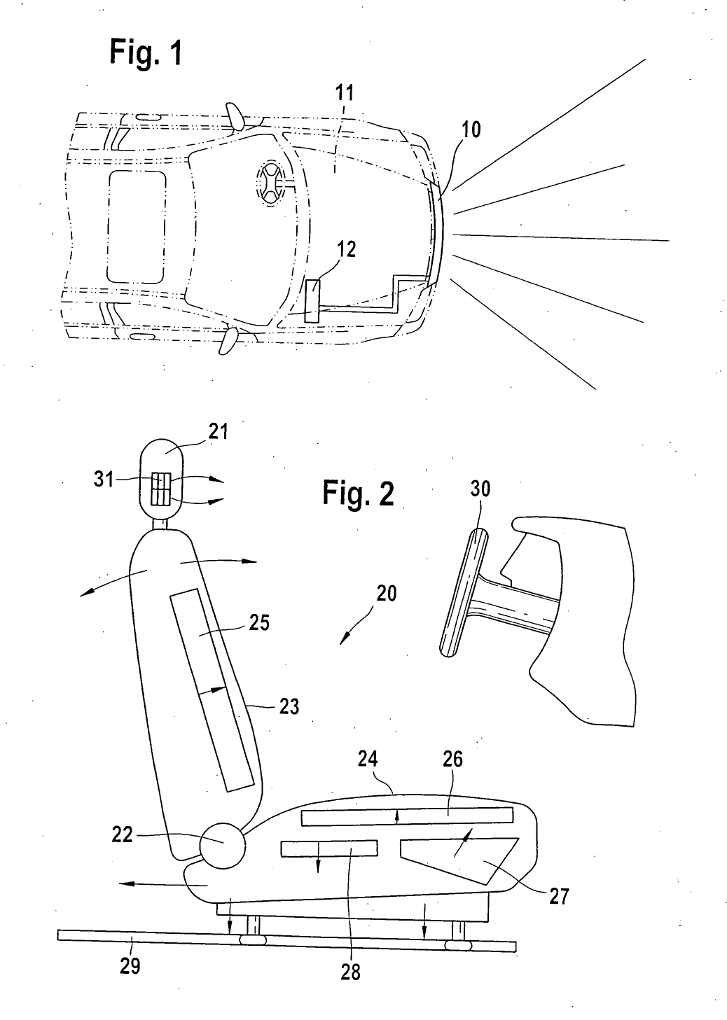

FIG. 1 illustrates a sensor device 10 having in the front region of a vehicle 11 at least one sensor for monitoring the surrounding area of the vehicle, in particular the surrounding area of the vehicle in the travel direction and/or counter to the travel direction. Sensor device 10 is connected to an evaluation device 12 and has radar sensors, video sensors and/or laser-scan-based sensors (lidar), for instance. Sensor device 10 is preferably arranged around the entire vehicle and is thus positioned to detect the entire surrounding field of the vehicle. The sensor signals detected by sensor device 10 are analyzed and processed in evaluation device 12. If a potential crash in which vehicle 11 is involved is detected with the aid of the sensor signals analyzed by evaluation device 12, evaluation device 12 triggers a comprehensive actuator system of a seat 20, in particular, according to FIG. 2.

Seat 20, adjustable as a function of the sensor signals detected by sensor device of 10 evaluation device 12 according to FIG. 1, has two adaptation speeds. A first adaptation speed is used for the comfort adjustment of seat 20. A second adaptation speed of adaptive seat 20 is higher than the first adaptation speed. It is provided for rapid adjustment of seat 20 in response to a trigger signal, which is generated by evaluation device 12 in a dangerous situation, such as a possible crash, detected by sensor device 10. Seat 20 has an adjustable headrest 21. Via an actuator 22, both the essentially perpendicular seat surface 23, i.e., the seat back, is adjustable and seat 20 in its entirety, in particular the essentially horizontal seat surface 24, these being displaceable toward the front or rear. Lateral seat ends 25 and 26, which are activatable by actuators, may emerge from seat surfaces 23, 24 in the event of a detected possible crash so as to ensure better lateral guidance and thus improved protection of an occupant. The actuators described herein are preferably triggered by the same electronic trigger device (not shown) that triggers the comfort seat adjustment, i.e., both at the first and also at the second, higher speed.

A seat wedge 27, which is arranged in the front region of essentially horizontal seat surface 24 and which is also activatable by an actuator, may be moved in an upward direction as well in a predicted crash, especially in conjunction with a reversible belt tightener (not shown in FIG. 2), in order to prevent an occupant from slipping under and thus through the seat belt, such sliding also being known as “submarining”. A similar effect, preferably in conjunction with a reversible belt tightener, is achieved by device 28, for instance a disk in the rear region of the essentially horizontal seat surface 24, which is able to be moved downward in a projected crash. Seat 20 is preferably mounted on a seat rail 29 on the vehicle floor and is able to be shifted with respect to a steering wheel 30 in a short time, preferably less than one second, as a function of the analyzed sensor data. A head/neck support 31 or collar, which is able to slide out in a reversible manner and is activatable via an actuator, is preferably provided in headrest 21.

Any device actuatable by an actuator 22, 25, 26, 27, 28, 31 is preferably activatable in a reversible manner. The actuators are high-speed electromotors, for instance, a pneumatic system or an electromotorically reversible, mechanical spring device. Using such an actuator system, the following actions are able to be triggered in seat 20 in a reversible manner: Moving seat 20 downward so as to provide more clearance with respect to the roof (not shown); activating seat wedge 27 in the frontal seating area of the essentially horizontal seat surface 24 to avoid submarining; creating a depression in the rear seating area of the essentially horizontal seat region 24 to prevent “submarining” in cooperation with a reversible belt tightener; erecting lateral seat ends 25, 26 to avoid sliding of the occupant(s); sliding a head protection (not shown in FIG. 2) out of the roof to prevent hard contact with the roof in the event of a rollover; sliding upholstered device 31 in the form of a type of collar out of the headrest to prevent pivoting motions of the head during a possible crash.

Furthermore, according to the present invention, the reversible and irreversible restraining means discussed earlier, such as pyrotechnically fired airbags, are mutually adjusted, preferably on the basis of the data acquired in evaluation device 12. In addition, the occupant is able to virtually experience the deployment of the safety device in this manner, and it additionally acts as warning function in critical traffic situations, no additional costs arising after triggering due to the reversibility of the actuator system in the seat.

Although the present invention was described above in light of a preferred exemplary embodiment, it is not restricted to such, but is able to be modified in various ways.

For instance, sensors other than the ones described are conceivable to monitor the surroundings of the vehicle, e.g., ultrasound or infrared sensors. In the same way, the enumeration of the described actuators should be considered an example and not a final number.

Although applicable to various vehicles, such as speedboats, airplanes, trucks etc., the present invention and the problem on which it is based are described with reference to a motor vehicle.

1-11. (canceled)

12. An occupant-protection system for a vehicle, comprising:
at least one sensor to detect a surrounding area of the vehicle and to generate sensor signals therefrom;
an evaluation device to analyze the sensor signals and to detect an approaching dangerous situation ahead of time according to an algorithm for the advance detection of a hazardous situation and generates a trigger signal in this case; and
a seat-adjustment device having at least one actuator for adjusting a seat, the seat-adjustment device having a first speed for the comfort adjustment of the seat, and a second, higher speed for the adjustment of the seat in response to a triggering by the trigger signal.

13. The occupant-protection system of claim 12, wherein at least one of the following is satisfied: (i) at least one of the seat surfaces and the headrest of the seat are reversibly deformable at the second speed in each case as a function of sensor signals analyzed by an evaluation device; and (ii) the seat position is able to be reversibly positioned with respect to a steering wheel.

14. The occupant-protection system of claim 12, wherein the at least one actuator is formed by a pneumatic system, a high-speed electromotor or an electromotorically tensionable, mechanical spring device, which brings the seat into a predefined final position.

15. The occupant-protection system of claim 14, wherein the seat is brought into position in less than one second.

16. The occupant-protection system of claim 12, wherein a seat wedge is provided at the front end of the essentially horizontal seat surface, which deforms the seat surface in an upward direction in response to the trigger signal.

17. The occupant-protection system of claim 12, wherein the seat has an actuator, which moves the seat at least one (i) in the direction of a seat-mounting device on the vehicle floor and (ii) away from the steering wheel in response to the trigger signal.

18. The occupant-protection system of claim 12, wherein the seat has in a rear region of the essentially horizontal seat surface a device which is movable in a downward direction by an actuator, the device producing a depression in the rear region of the seat surface in response to the trigger signal.

19. The occupant-protection system of claim 12, wherein the essentially perpendicular seat surface has seat ends, which are slidable out laterally in response to the trigger signal.

20. The occupant-protection system of claim 12, wherein at least one of the following is satisfied: (i) the headrest has an integrated collar; and (ii) the interior side of the roof of the vehicle has a flush-mounted headrest bolster above the seat, which slides out in response to the trigger signal.

21. The occupant-protection system of claim 12, wherein the sensor device has at least one of radar sensors, video sensors, laser-scan-based sensors and IR sensors at the periphery of the vehicle, for monitoring the surrounding area in at least one of the travel direction and counter to the travel direction.

22. A method for activating an occupant-protection system for a vehicle:
detecting a surrounding area of the vehicle using at least one sensor and generating sensor signals therefrom;
evaluating the sensor signals according to an algorithm for the advance detection of a hazardous situation, and advance detecting an approaching hazardous situation and generation of a trigger signal in an evaluation device in this case; and
adjusting a seat having a seat-adjustment device including at least one actuator, the seat-adjustment device having a first speed for the comfort adjustment of the seat, and a second, higher speed for the adjustment of the seat in response to triggering by the trigger signal.

23. The method of claim 22, wherein, in response to the trigger signal, the at least one actuator brings the seat into a position that is safe for an occupant, using the second speed.
